(19) United States
(12) Patent Application Publication
(10) Pub. No.: US 2005/0089232 A1
(43) Pub. Date: Apr. 28, 2005

(54) METHOD OF VIDEO COMPRESSION THAT ACCOMMODATES SCENE CHANGES

(76) Inventors: Chun-Ming Hsu, Taipei City (TW); Yueh-Yi Wang, Tai-Chung City (TW); Ai-Chieh Lu, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,746

(22) Filed: Oct. 23, 2003

(51) Int. Cl. G06K 9/36

(52) U.S. Cl. 382/236; 382/239

(57) ABSTRACT

A method provides a predetermined sequence of video frames, the predetermined sequence beginning with an I-frame, ending with a P-frame, and having intermediate B-frames. The method encodes blocks of each frame according to the order of the frame in the sequence and the frame type, determines a number of intra picture coded blocks in an encoded P-frame, and determines that a scene change occurs when the number of intra-picture encoded blocks is greater than a predetermined number. The method redefines the P-frame detected as having a scene change as an I-frame, redefines all B-frames of the sequence as P-frames, and re-encodes redefined frames while detecting for the scene change in the newly defined P-frames.

### BACKGROUND OF INVENTION

1. Field of the Invention

The present invention relates to digital video, and more specifically, to a method of video frame compression.

2. Description of the Prior Art

Digital video is a popular means of information communication. Computer-based video conferencing and digital television are just two examples of applications of this technology. As a single digital image can contain hundreds of thousands of pixels and many sequential image frames are required to produce a quality video effect, compression schemes are required for efficiency in processing time and storage space.

In general, image compression is effected by determining correlations among regions of pixels. When high compression is required due to limits in data transmission speeds for example, either video quality must be sacrificed or additional compression hardware and software must be provided. Where low amounts of compression are tolerable, video quality can be maintained at the cost of an increase in memory demand. Among this complex arrangement of trade-offs, any increase in compression that does not significantly lower video quality or increase the necessary hardware is undoubtedly beneficial.

Practically, compression of a video frame can be realized by intra-picture encoding in which a block of pixels is compressed referencing pixel information outside the block but in the same frame, and by inter-picture encoding in which a block is compressed referencing pixel information of other frames. In compression standards, such as MPEG-4, it is convenient to define several types of frames each having different compression schemes. Commonly, these types of frames are defined as: an entirely intra-picture encoded frame (I-frame), a frame having a mixture of intra-picture and inter-picture encoded blocks (P-frame), and a frame of only inter-picture encode blocks (B-frame). The I-frame is the least compressed and has the highest picture quality, the B-frame is the most compressed and sacrifices some picture quality, and the P-frame is fairly balanced in between. Such definitions allow for controlling the trade-off between compression and quality in systems such as MPEG-4.

Once frame type definitions are decided upon, a predetermined sequence, which is typically repeating, of these frames is used to encode a video. Please refer to FIG. 1 illustrating a sequence 10 of five frames 12-20. Frame 12 is an I-frame, frames 14, 16, 18 are B-frames, and frame 20 is a P-frame. The I-frame 12 is encoded first, its blocks (i.e. intra block 22) being encoded referencing in-frame picture information only. The B-frames 14, 16, 18 are encoded next. The blocks of the B-frames (i.e. inter blocks 24, 26, 28) are encoded using motion vectors referencing picture information of the I-frame 12. Finally, the P-frame is encoded using a suitable combination of intra-picture encoding (i.e. block 30) and inter-picture encoding (i.e. block 32). With such an “I-B-B-B-P” frame sequence, a reasonable balance of compression and quality can be maintained.

A major problem with this method occurs at scene changes, such as those that frequently occur during movies. From a video compression standpoint, a scene change can be loosely defined as: when the pictures to be encoded change drastically between two neighboring frames. If the scene of the video changes at a B-frame, the reference of that B-frame (the preceding I-frame) likely contains little useful information with which to encode that B-frame (Recall that B-frames consist entirely of inter-picture encoded blocks with corresponding motion vectors referring back to a reference frame.). For example, if the I-frame 12 (FIG. 1) contains an image of an automobile travelling down a highway, and the B-frame 14 is required to have a similar image with the automobile displaced slightly, there is no problem. However, if the scene then changes and the B-frame 16 is required to have an image of a man eating a salad, poor encoding of the B-frame 16 will result as the I-frame 12 holds little useful image information with which to perform inter-picture encoding. Thus, scene changes occurring in B-frames degrade overall video quality.

### SUMMARY OF INVENTION

It is therefore a primary objective of the claimed invention to provide a method of video compression capable of handling a scene change occurring in an inter-coded frame (B-frame) to improve video quality.

Briefly summarized, the claimed invention method includes providing a predetermined sequence of video frames, the predetermined sequence beginning with an I-frame and ending with a P-frame. An I-frame is defined as having blocks encoded referencing intra-picture information only and a P-frame is defined as having blocks encoded referencing intra-picture or inter-picture information. Further, a B-frame is defined as having blocks encoded referencing inter-picture information only. The method further includes encoding blocks of each frame according to the order of the frame in the sequence and the frame type, determining a number of intra-picture coded blocks in an encoded P-frame, and determining that a scene change occurs when the number of intra-picture coded blocks is greater than a predetermined number. The method finally includes redefining the P-frame detected as having a scene change as an I-frame, redefining all B-frames of the sequence as P-frames, and re-encoding redefined frames.

According to the claimed invention, method further includes detecting for a scene change in the newly redefined frames. Such an iterative approach allows the exact frame in which the scene change occurs to be determined.

It is an advantage of the claimed invention that redefining frames allows a scene change to be accurately encoded thereby improving overall video quality.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a sequence of video frames according to the prior art.

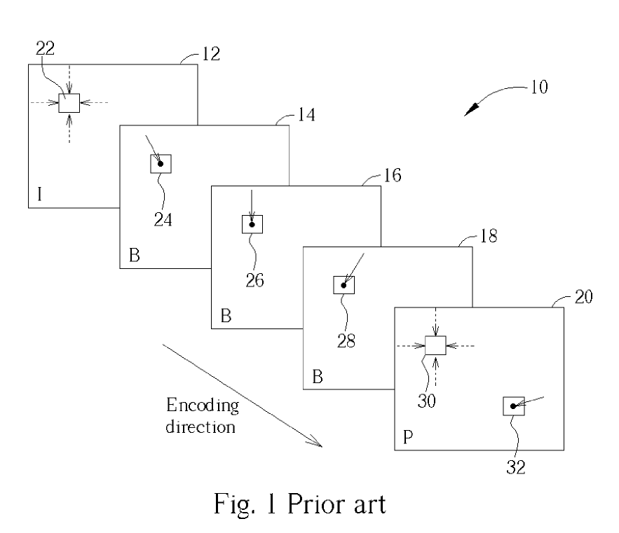

FIG. 2 is a block diagram of a video system for performing the present invention method.

FIG. 3 is a flowchart of the present invention method.

FIG. 4 is a frame diagram relating to FIG. 3.

FIG. 5 is a frame diagram of a video encoded according to the present invention method.

### DETAILED DESCRIPTION

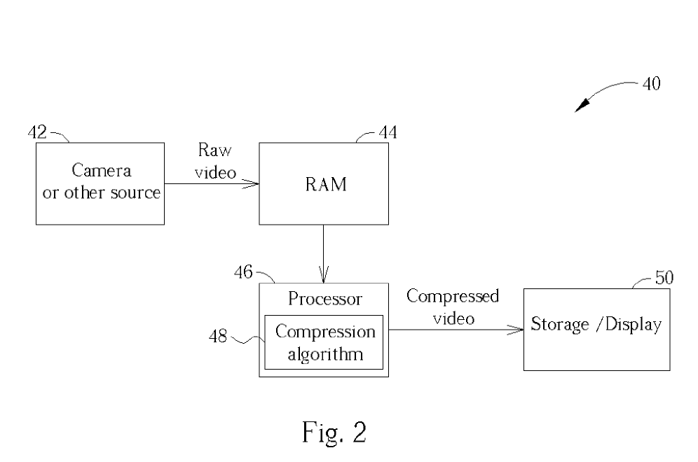

FIG. 2 illustrates a video system 40 capable of performing the present invention compression method. The video system 40 comprises a random-access memory 44 and a processor 46 for executing a compression algorithm 48 according to the present invention. The compression algorithm 48 may be stored in the RAM 44 or in a similar memory dedicated to the processor 46. The video system 40 receives a raw video signal from a video source 42, such as a digital video camera, at the RAM 44 though an interface (not shown). The processor 46 then executes the compression algorithm 48 on the raw video data stored in the RAM 44 and outputs compressed video data to a display or storage device 50 via an output interface (not shown). In practical applications, the video source 42, the RAM 44, processor 46, and the display 50 may be part of a digital camera or a personal computer system. Likewise, the source 42 may be a computer-based digital camera, with the RAM 44 and processor 46 being part of the computer, the display device 50 being a remote monitor to which compressed video is sent across a network.

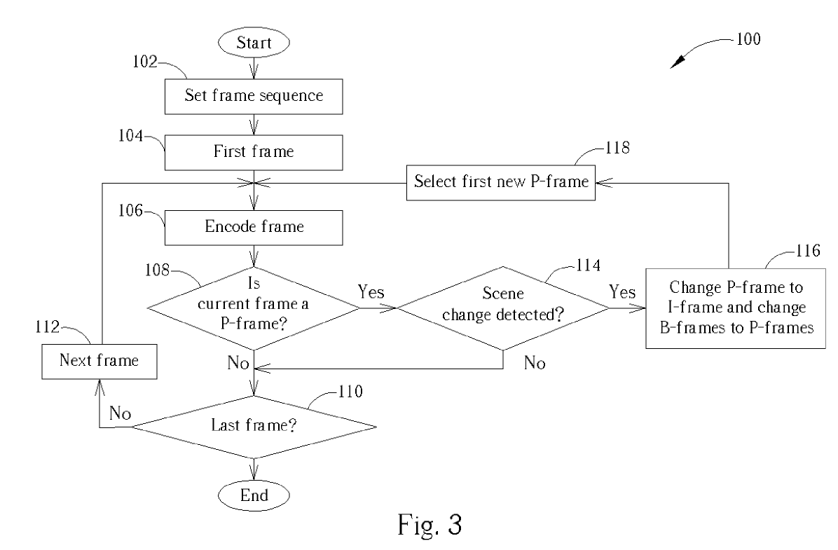

FIG. 3 illustrates a flowchart of the present invention method. The process 100 described by the flowchart can be practically realized as the compression algorithm 48 of FIG. 3 and is described as follows:

Step 102: Select a frame sequence of I-, B-, and P-frames (for example, “I-B-B-B-P”);

Step 104: Select the first frame to be encoded (i.e. the I-frame);

Step 106: Encode the frame according to its type. Blocks of an I-frame are intra-picture encoded referencing only picture information of the current frame, blocks of a B-frame are inter-picture encoded referencing picture information of the previous I-frame, and blocks of a P-frame are intra- or inter-picture encoded depending on the relative suitability of each;

Step 108: Check the type of the current frame being encoded. This can be performed before, after, or during encoding. If the current frame is a P-frame perform step 114, otherwise continue with step 110;

Step 110: If the current frame is the last frame to be encoded, end the process. Otherwise, perform step 112;

Step 112: Select the next frame. Note that the frame sequence is repeated such that another I-frame comes after the P-frame in the exemplary sequence;

Step 114: Is a scene change detected in the P-frame? That is, does the number of intra-picture encoded blocks exceed a predetermined limit? If a scene change is detected, perform step 116. Otherwise, continue with step 110;

Step 116: Change the current frame from a P-frame to an I-frame, and change B-frames in the current frame sequence to P-frames;

Step 118: Select the first of the newly converted P-frames.

Regarding the P-frame encoding of step 106, determining whether a block is to be intra-picture encoded or inter-picture encoded is well known in the art. For example, a P-frame encoding algorithm may encode all blocks as inter-picture by default, unless such encoding results in a quality indicator value that is less than acceptable. The algorithm would select blocks with unacceptable inter-picture encoding quality to be encoded as intra-picture instead.

Regarding the scene change detection in step 114, this can be performed in several ways. In the preferred embodiment, a running total of intra-picture encoded blocks is kept while encoding a P-frame. If the running total exceeds a certain limit, then a scene change is said to be detected. For example, in a 640×480 pixel video having 16×16 pixel non-overlapping blocks (1200 blocks total), the limit of intra-picture encoded blocks can be selected as 800. Thus, if an 801st block is to be intra-picture encoded, a scene change is determined. Of course, another limiting value could be selected for a different tolerance to scene change detection. Note that, if a scene change is detected in the P-frame, the scene change may actually occur in the P-frame itself or in any preceding B-frame. The exact frame in which the scene change occurs is determined by the iterative nature of the process 100.

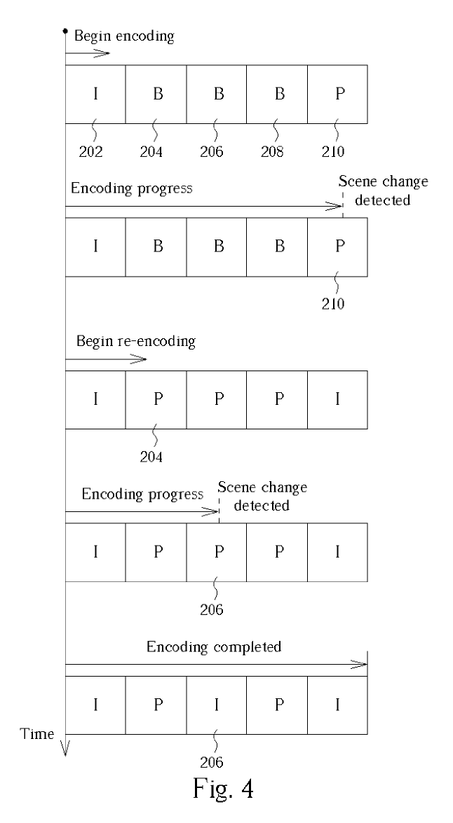

Please refer to FIG. 4 illustrating frame sequences as an example of the effect of the process 100. In FIG. 4, the frame sequence (frames 202-210 corresponding to an “I-B-B-B-P” sequence) is initially selected in step 102 of the process 100. Encoding begins with this sequence according to steps 104 and 106. Then, during step 114, the P-frame 210 is detected to have a scene change. Subsequently, according to step 116, the frame sequence is revised to “I-P-P-P-I”. That is, the format of the frames 204, 206, 208 is changed from B-frame to P-frame and the format of the frame 210 is changed from P-frame to I-frame. The first P-frame of the new sequence, P-frame 204, is selected in step 118 and encoding thus continues. Many of the blocks of a P-frame that was formerly a B-frame will be re-encoded as intra-picture blocks, however, re-encoding blocks that are to remain inter-picture encoded is unnecessary. During continued encoding, step 114 again detects the scene change based on the number of intra-picture blocks generated, however, this time it occurs in the second P-frame 206. Accordingly, the P-frame 206 is re-encoded as an I-frame. Since at this point no B-frames exist to be converted to P-frames, encoding continues until complete.

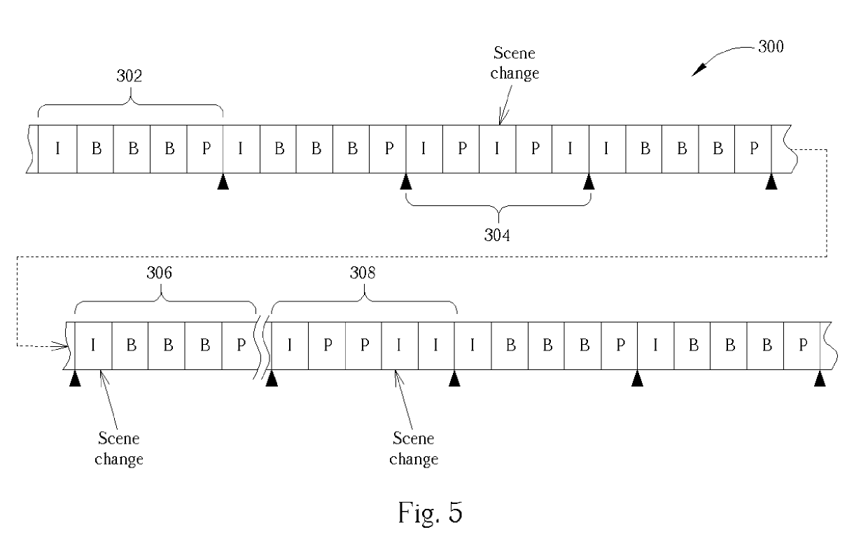

FIG. 5 illustrates a video 300 encoded according to the present invention method. The video 300 is made up of a series of frame sequences that are initially defined as “I-B-B-B-P”. However, during compression, the process 100 detects scene changes and changes frame types accordingly. The video 300 includes a frame sequence 302 having no scene change (which is typical), a frame sequence 304 having a scene change in the third frame (as in FIG. 4), a frame sequence 306 having a scene change in the first frame, and a frame sequence 308 having a scene change detected in the fourth frame. Note that the present invention method 100 handles the scene change of the frame sequence 304 occurring in the I-frame, even though no frame redefinitions are necessary. As a result, the exact frames in which scene changes occur are determined, these frames being encoded to preserve such scene changes.

In practical application, the present invention can be implemented as part of an MPEG-4 (moving picture experts group) video compression program or device. Implementation of the above-described method 100 into an MPEG-4 system is straightforward to one of ordinary skill in the art.

In contrast to the prior art, the present invention redefines frames to accurately encode a scene change. Specifically, when a scene change is detected in a P-frame, the P-frame is converted to an I-frame and any B-frames in the same sequence are converted to P-frames. As a result, the exact frame in which the scene change occurs can be determined, and the scene change can be properly encoded.

Those skilled in the art will readily observe that numerous modifications and alterations of the device may be made while retaining the teachings of the invention. Accordingly, the above disclosure should be construed as limited only by the metes and bounds of the appended claims.

1. A method of compressing a sequence of video frames, video frames comprising blocks of picture information; types of video frames being: an I-frame having blocks encoded referencing intra-picture information only, a P-frame having blocks encoded referencing intra-picture or inter-picture information, and a B-frame having blocks encoded referencing inter-picture information only; the method comprising:
(a) providing a predetermined sequence of video frames, the predetermined sequence beginning with an I-frame and ending with a P-frame;
(b) sequentially encoding frames by encoding blocks of each frame according to the frame type;
(c) determining a number of intra-picture encoded blocks in a P-frame, and determining a scene change as occurring when the number of intra-picture encoded blocks is greater than a predetermined number; and
(d) when detecting a scene change in a P-frame, redefining that P-frame as an I-frame and redefining B-frames of the sequence as P-frames, and re-encoding redefined frames.

2. The method of claim 1 wherein steps (b), (c), and (d) are repeated for all new P-frames generated in a previous execution of step (d).

3. The method of claim 1 wherein the predetermined sequence consists of: an I-frame, a subsequent series of B-frames, and a final P-frame.

4. The method of claim 1 wherein in step (c), the number of intra-picture encoded blocks is maintained and compared to the predetermined number while encoding the P-frame.

5. The method of claim 1 wherein in step (d) all B-frames of the sequence are redefined as P-frames.

6. The method of claim 1 wherein the sequence of video frames and the encoding of the video frames are according to MPEG-4.
